(19) United States
(12) Patent Application Publication
(10) Pub. No.: US 2003/0233900 A1
(43) Pub. Date: Dec. 25, 2003

(54) Rotary transmission device

(75) Inventors: Naoki Fujikawa, Hino-shi (JP); Moriya Katagiri, Tokyo (JP); Tatsuo Takanashi, Hachioji-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/422,462

(22) Filed: Apr. 24, 2003

(30) Foreign Application Priority Data
Apr. 26, 2002 (JP) 2002-127245
Aug. 8, 2002 (JP) 2002-231121

(51) Int. Cl. F16H 55/08

(52) U.S. Cl. 74/457

(57) ABSTRACT

A gear structure of the present invention comprises a first gear and a second gear. A teeth portion constituting a gear portion of the second gear are provided, in a partial area in its tooth width direction, with regulating portions formed into a shape which is cut so as to have a diameter smaller than an external diameter of a tooth top. Furthermore, the first gear is provided with fitting portions into which the regulating portions of the second gear are fitted. The regulating portions of the second gear are fitted into the fitting portions of the first gear so that they may be integrally stacked and arranged.

### CROSS-REFERENCE TO RELATED APPLICATIONS

This application is based upon and claims the benefit of priority from the prior Japanese Patent Applications No. 2002-127245, filed Apr. 26, 2002; and No. 2002-231121, filed Aug. 8, 2002, the entire contents of both of which are incorporated herein by reference.

### BACKGROUND OF THE INVENTION

1. Field of the Invention

The present invention relates to a gear structure used in, for example, a rotary transmission mechanism of a camera or the like.

2. Description of the Related Art

Heretofore, the so-called stepped gears, in which different spur gears are coaxially stacked and arranged, are provided in a rotary transmission mechanism of a camera or the like by gears. In such stepped gears, one of the spur gears may be formed by a molding technique in compliance with a use purpose such as torque to be transmitted, and the other spur gear to which high torque is applied may be formed of a metallic material. According to means for producing the stepped gears, a round boss is formed on one rotation axis of the one spur gear, and a round hole is oppositely formed on the same rotation axis of the other spur gear. Then, the round boss is pressed into the round hole, thereby producing the stepped gears which are integrally stacked and arranged.

However, if the large torque is applied between the gears of the stepped gears, a problem occurs in which the so-called slip is caused between the spur gears, so that stable transmission of a driving force is difficult.

Therefore, a pressing structure has been employed in which the round boss and the round hole formed in the spur gears are replaced with, for example, oval bosses and holes. Then, these oval bosses are pressed into the oval holes so that the gears may be integrally stacked and arranged, thereby increasing rigidity in a rotating direction. In this pressing structure, even if the relatively high torque is applied between the gears, and the stable transmission of the driving force can be achieved without causing the slip between them.

However, in the above pressing structure, its configuration becomes complicated, and hence, when the stepped gears are formed of the metallic material, it is necessary to carry out complicated machining such as milling for their processing. In consequence, such a structure has an inconvenience that the production of the gears is very troublesome and costly.

The conventional stepped gears have a disadvantage that the increase of the torque to be applied might cause the slip between the gears, and if they are constituted so as to prevent the slip, the processing becomes troublesome and costly.

### BRIEF SUMMARY OF THE INVENTION

A feature of the present invention is therefore to provide a gear structure having a simple constitution, realizing convenient, inexpensive and easy production, and enabling stable and highly accurate transmission of a driving force.

According to the first feature of the present invention, there is provided a rotary transmission device comprising:

a first rotary member having a plurality of radial concave portions around a rotary central axis in the vicinity of the rotary central axis; and

a second rotary member formed as a gear, a tooth width of each tooth of the gear being reduced from a tip of the tooth to a halfway point of a tooth height, a tooth portion of from the halfway point of the tooth height to a tooth root being fitted into the plurality of concave portions, whereby the second rotary member does not relatively rotate with the first rotary member.

According to the second feature of the present invention, there is provided a rotary transmission device comprising:

a first rotary member having a plurality of radial concave portions around a rotary central axis in the vicinity of the central axis; and

a second rotary member which is a gear, having a thin portion as a gear portion in which a tooth width of each tooth of the gear is additionally processed to reduce the tooth width from a tip of the tooth to a halfway point of a tooth height, and a plurality of thick portions which are tooth portions and are not additionally processed from the halfway point of the tooth height to a tooth root, the plurality of thick portions being fitted into the plurality of concave portions, respectively, whereby the second rotary member does not relatively rotate with the first rotary member.

According to the third feature of the present invention, there is provided a gear mechanism comprising:

a first gear;

a second gear to engage with the first gear;

a first outer peripheral surface portion provided to rotate coaxially and integrally with the first gear; and

a second outer peripheral surface portion provided to rotate coaxially and integrally with the second gear,

wherein to keep a space between axes of the first gear and the second gear at a certain distance, the first outer peripheral surface portion and the second outer peripheral surface portion are allowed to contact or adjoin each other, so that the first gear engages with the second gear.

According to the fourth feature of the present invention, there is provided a gear mechanism comprising:

a first gear;

a second gear to engage with the first gear;

a first outer peripheral surface portion provided coaxially and integrally with the first gear; and

a second outer peripheral surface portion to rotate coaxially and integrally with the second gear,

wherein to keep a space between axes of the first gear and the second gear at a certain distance, the first outer peripheral surface portion and the second outer peripheral surface portion are allowed to contact or adjoin each other, so that the first gear engages with the second gear.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exploded perspective view showing by exploding a gear structure according to a first embodiment of the present invention;

FIG. 2 is a perspective view showing essential portions of a first gear of FIG. 1;

FIG. 3 is a plan view showing the first gear and a second gear of FIG. 1 stacked and arranged;

FIG. 4 is a sectional view showing by sectioning the essential portions of FIG. 3;

FIG. 5 is a sectional view showing the gear structure of FIG. 1 in a state incorporated in a device body;

FIG. 6 is an exploded perspective view showing by exploding a gear structure according to a second embodiment of the present invention;

FIG. 7 is an exploded perspective view showing by exploding a gear structure according to a third embodiment of the present invention;

FIG. 8 is an exploded perspective view of a gear structure and its peripheral portions according to a fourth embodiment of the present invention; and

FIG. 9 is a sectional view of the gear structure of FIG. 8.

### DETAILED DESCRIPTION OF THE INVENTION

Embodiments of the present invention will hereinafter be described in detail in reference to the drawings.

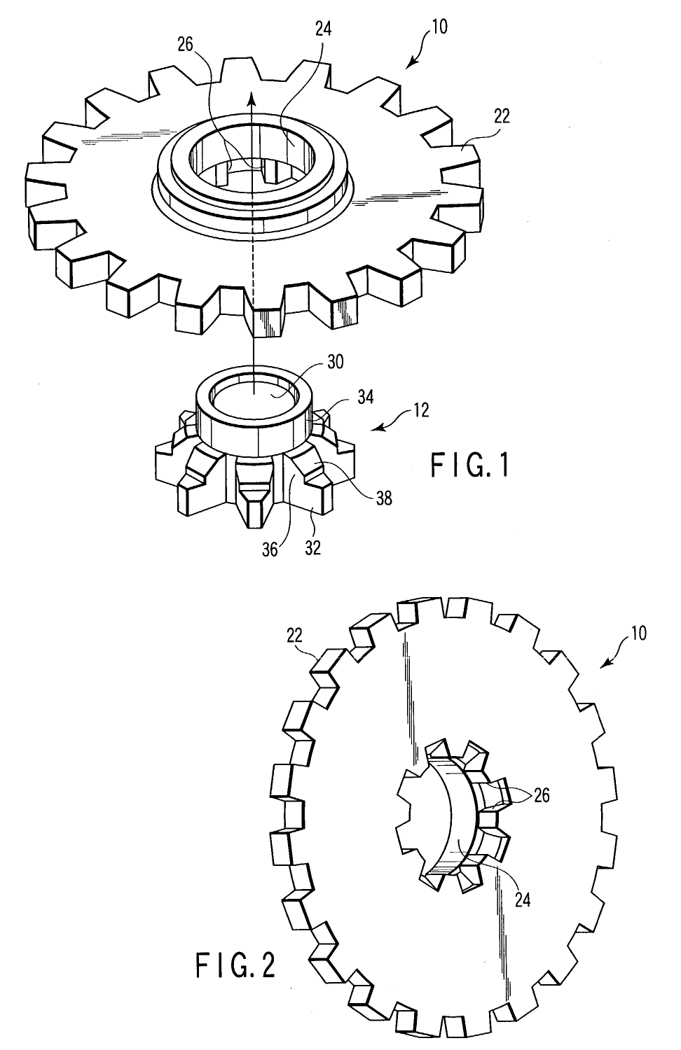

FIG. 1 is a perspective view showing a gear structure regarding a first embodiment of the present invention. In FIG. 1, a first gear 10 constitutes, for example, a driving side member as a transmission member, and is rotated and driven, for example, by a driving force transmitted from a driving source not shown. On the above first gear 10, for example, a second gear 12 having a smaller diameter, which constitutes a driven side member as a transmission member, is integrally stacked so as to be arranged in a combined state.

In the first gear 10, a plurality of teeth 22, which is a gear portion having a predetermined tooth top external diameter by, for example, molding, is formed at predetermined intervals. A pressing hole 24 is formed in the center of the first gear 10. Further, a plurality of concave fitting portions 26 is formed at predetermined intervals at one end of the pressing hole 24 in the first gear 10, as shown in FIG. 2.

On the other hand, the second gear 12 is formed of, for example, a metallic material, and a shaft fitting hole 30 is provided in its central portion. A plurality of teeth 32, which constitutes a gear portion having a predetermined tooth top external diameter, is formed at predetermined intervals around the shaft fitting hole 30 of the second gear 12.

On one side of the second gear 12, a convex pressing portion 34, which is formed by cutting each teeth 32, for example, into a smaller diameter from a tooth top external diameter, is coaxially formed around the shaft fitting hole 30. The pressing portion 34 is coaxially formed correspondingly to the pressing hole 24 formed in the first gear 10.

Furthermore, the second gear 12 is provided with a plurality of regulating portions 36 between its teeth 32 and pressing portion 34. The regulating portions 36 are formed at predetermined intervals correspondingly to the plurality of concave fitting portions 26 formed in the first gear 10 mentioned above.

In addition, the regulating portions 36 are, for example, formed in each teeth 32 in a stepped shape cut into a smaller diameter by predetermined dimensions than a tooth top external diameter in its tooth width direction. Further, the regulating portion 36 is formed in a shape provided, in its central portion, with an inclined surface 38 inclined in an axial direction. The provision of the inclined surface 38 makes it easy to find a rotating direction position during a pressing operation.

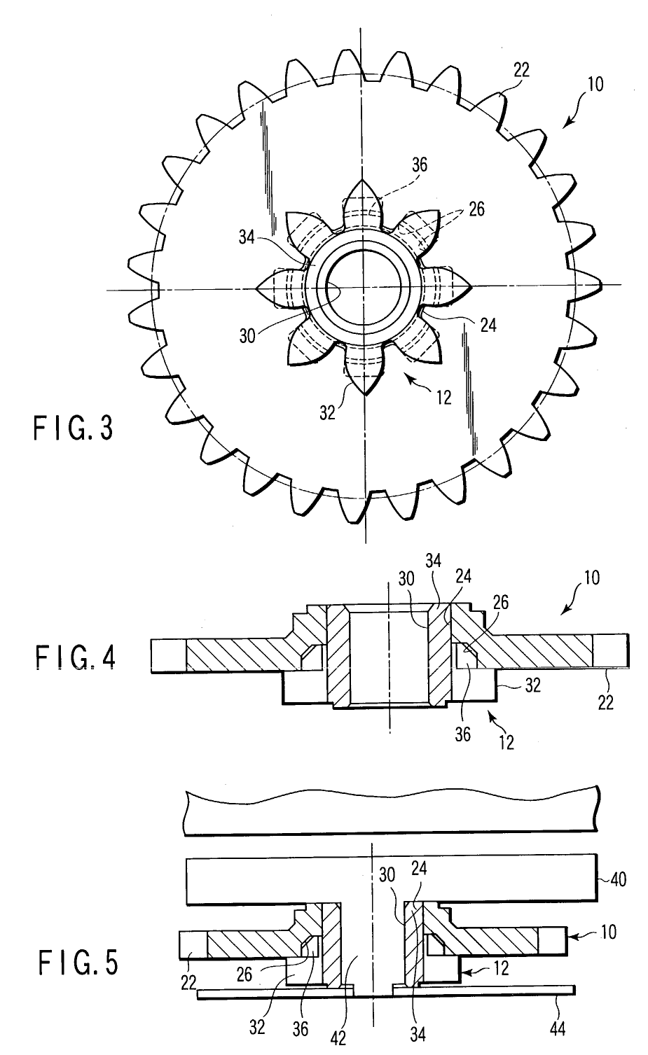

In such constitution, when the first gear 10 and second gear 12 are stacked and arranged, the pressing portion 34 of the second gear 12 is pressed into the pressing hole 24 of the first gear 10, as shown in FIGS. 3 and 4. At this point, the regulating portions 36 of the second gear 12 are fitted into the fitting portions 26 of the first gear 10. In this way, positions of the first and second gears 10 and 12 in the direction of the rotation axis are decided by the mutual function of the pressing hole 24 and pressing portion 34. Then, they are integrated in a stacked state and thus combined, while the fitting portions 26 and regulating portions 36 function to decide the position in the rotating direction between the gears.

The shaft fitting hole 30 of the second gear 12 stacked and arranged is, for example, fitted into by a support shaft 42 provided for a film winding device body 40, as shown in FIG. 5. At an end of the support shaft 42, a presser plate 44 is provided, which is a presser plate to regulate the first and second gears 10 and 12 in the axial direction.

In this state, the first gear 10 is rotated and driven on the device body 40 via the support shaft 42, by a driving force transmitted from the driving source (not shown). Here, the second gear 12 is integrally rotated and driven in conjunction with the rotation of the first gear 10, thereby rotating and driving, for example, a driving portion in the device body 40, and performing a desired operation.

In this way, in the above gear structure, the teeth 32 constituting the gear portion of the second gear 12 are provided, in a partial area in a tooth width direction, with the regulating portions 36 forming a shape which is cut to have a diameter smaller than an external diameter of a tooth top. Further, the first gear 10 is provided with the fitting portions 26 into which the regulating portions 36 of the second gear 12 are fitted. Moreover, the regulating portions 36 of the second gear 12 are built to fit into the fitting portions 26 of the first gear 10 so that they are integrally stacked and arranged.

In this way, the regulating portions 36 are formed in the teeth 32 of the second gear 12, and the fitting portions 26 into which the regulating portions 36 are fitted are formed in the first gear 10 so that they are fitted and integrated, thereby making it possible to form the regulating portions 36 provided in the second gear 12 into a shape capable of surely preventing a slip merely by cutting the partial area of the teeth 32, and achieving simple and easy production. In other words, when the second gear 12 is formed of, for example, a metallic material, it is possible to, after once forming the teeth 32 having the tooth top external diameter, produce the partial area of the tooth top by the machining of simply cutting into the cut shape mentioned above, thereby enabling simple and easy processing.

Furthermore, the above gear structure is constituted in a manner that the regulating portions 136 and the pressing portion 34 are coaxially provided in the second gear 12, and the fitting portions 26 and the pressing hole 24 are coaxially provided in the first gear 10, so that the pressing portion 34 of the second gear 12 is pressed into the pressing hole 24 of the first gear 10, and the regulating portions 36 are fitted into the fitting portions 26, thereby integrally arranging and stacking them.

In this way, the first gear 10 and the second gear 12 are integrally stacked and arranged while the position of each gear of the gear structure is decided in the rotating direction and axial direction by the regulating portions 36 and the fitting portions 26, and by the pressing portion 34 and the pressed portion 24, thereby enabling a rigid combination arrangement.

It should be noted that in the embodiment described above, such constitution has been described as an example that the fitting portions 26 of the first gear 10 are formed in about the same shape as the regulating portions 36 of the second gear 12 to decide the position in the rotating direction, but it is not limited to this, and it is also possible to configure the shape of the fitting portions 26 of the first gear 10 in a manner that, for example, the shape except in the rotation axis direction for deciding position has a larger diameter.

Furthermore, in the embodiment described above, such constitution has been described as an example that the regulating portions 36 are formed in all the teeth 32 of the second gear 12 so that all these regulating portions may fit into the fitting portions provided in the first gear, but it is not limited to this. Alternatively, it is also possible to constitute in such a manner that the regulating portions 36 are provided only in one or more desired teeth 32, and the regulating portions 36 are fitted into the fitting Portions 26 of the first gear 10 so as to decide the position in the rotation axis direction.

Still further, in the embodiment described above, such constitution has been described as an example that only the position in the rotation axis direction is decided by means of the regulating portions 36 and the fitting portions 26, but it is also possible to constitute in a manner that the position in the rotation axis direction is decided by means of the regulating portions 36 and the fitting portions 26, and at the same time, the position in the rotation axis direction is decided by pressing. In this case, the pressing hole 24 of the first gear 10 and the regulating portions 36 of the second gear 12 are used not for pressing but for deciding the position in the diameter direction.

Further yet, in the embodiment described above, such constitution has been described as an example that the first gear 10 is molded and the second gear 12 is formed of a metallic material, but it is not limited to this, but alternatively, it is also possible to constitute in such a manner that, for example, the first gear 10 is formed of a metallic material and the second gear 12 is molded, or that both the first and second gears 10 and 12 are formed of the same material.

In addition, in the embodiment described above, such constitution has been described as an example that the first gear 10 is rotated and driven by the driving source (not shown), but it is not limited to this, and it is also possible to constitute in such a manner that the second gear 12 is rotated and driven as a driving side member by the driving force transmitted from the driving source (not shown).

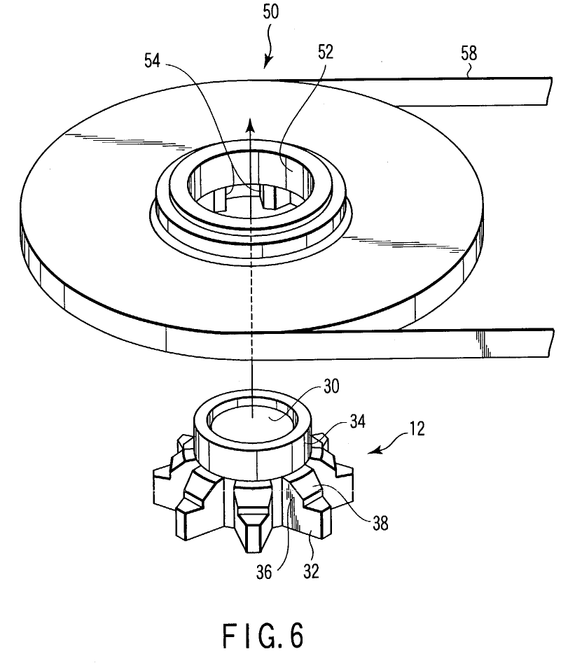

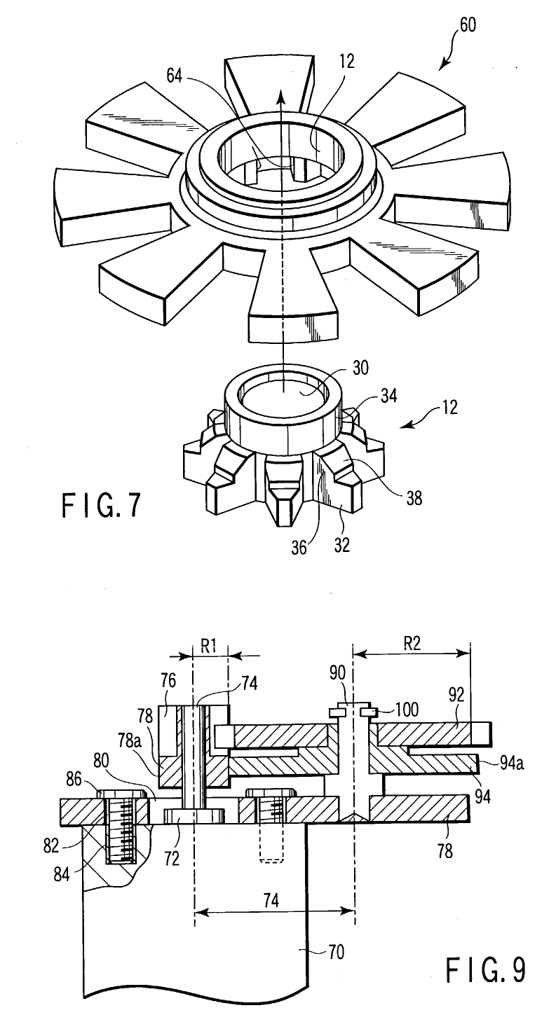

Moreover, the present invention is not limited to the embodiment described above, but alternatively, it is also possible to constitute as shown in FIGS. 6 and 7, whereby about the same effect can be expected. In addition, in the embodiments described below, the same portions as those in the first embodiment described above are given the same reference numerals for the sake of convenience and will not be described.

FIG. 6 is an exploded perspective view showing by exploding a gear structure according to a second embodiment of the present invention.

As shown in FIG. 6, the gear structure according to the second embodiment is constituted to form the driving side member with a pulley 50 and form the driven side member with the second gear 12. More specifically, in the pulley 50, a pressing hole 52 into which the pressing portion 34 of the second gear 12 is pressed and fitting portions 54 into which the regulating portions 36 of the second gear 12 are fitted are each formed. Then, the pressing portion 34 and regulating portions 36 of the second gear 12 are pressed and fitted into the pressing hole 52 and fitting portions 54 so that the members are integrally stacked and arranged. In this case, a driving belt 58 is wound and hung around the pulley 50, and the pulley 50 is rotated and driven via this driving belt 58, and in conjunction with this, the second gear 12 is rotated and driven.

FIG. 7 is an exploded perspective view showing by exploding a gear structure according to a third embodiment of the present invention.

The third embodiment shown in FIG. 7 is constituted in such a manner that the driven side member is formed by a bladed wheel 16 and the driving side member is formed by the second gear 12. More specifically, in the bladed wheel 60, a pressing hole 62 into which the pressing portion 34 of the second gear 12 is pressed and fitting portions 64 into which the regulating portions 36 of the second gear 12 are fitted are each formed, and the pressing portion 34 and regulating portions 36 of the second gear 12 are pressed and fitted into the pressing hole 62 and fitting portions 64 so that the members are integrally stacked and arranged. The second gear 12 is engaged with an unshown driving source in a manner that a driving force can be transmitted, and in conjunction with the rotation and driving, the bladed wheel 60 is rotated and driven.

This bladed wheel 60 is provided, for example, in an optical path of a light emitting portion and a light receiving portion of a photointerruptor, and is used to, in conjunction with the rotation, intermittently interrupt the optical path of the light emitting portion and light receiving portion.

Next, a forth embodiment of the present invention will be described.

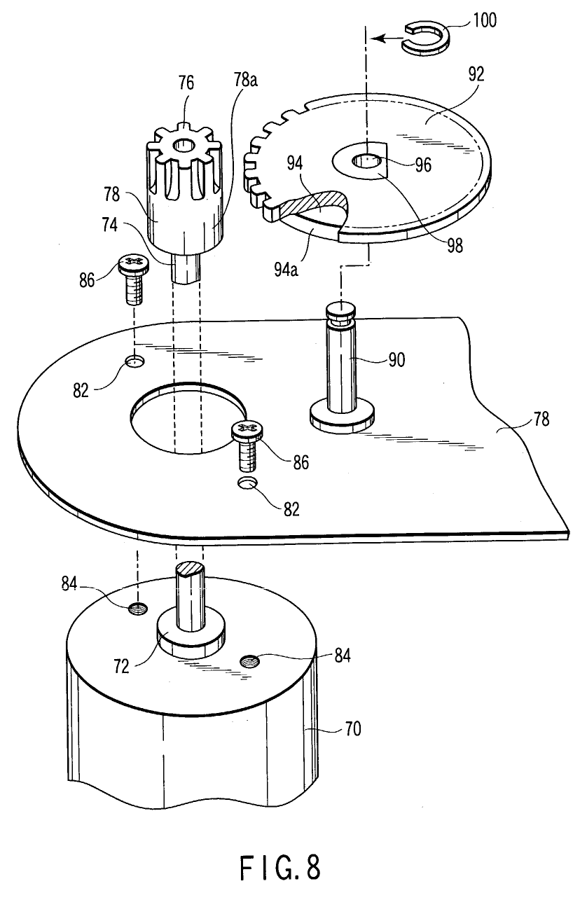

FIG. 8 is an exploded perspective view of a gear structure and its peripheral portions according to the fourth embodiment of the present invention, and FIG. 9 is a sectional view of the gear structure of FIG. 8.

In FIGS. 8 and 9, a pinion gear (drive gear) 76 as the first gear is pressed into a motor shaft 74, which is extended from a motor bearing 72 projecting from and formed on the surface of a motor 70. Further, under the pinion gear 76, an interaxial distance maintaining disc 78 is formed. The interaxial distance maintaining disc 78 is constituted as a first outer peripheral surface portion which is coaxially provided to rotate with the pinion gear 76. This enables the pinion gear 76 and the interaxial distance maintaining disc 78 to turn integrally with the motor shaft 74.

A bottom board hole 80 having a diameter larger than the diameter of the pinion gear 76 is formed on a bottom board 78. The pinion gear 76 is inserted through the bottom board hole 80. Further, motor fixing screws 86, 86 are tightened into screw holes 84, 84 of the motor 70 via screw fixing holes 82, 82, thereby fixing the motor 70 on the bottom board 86.

The bottom board 86 is also provided with a support shaft 90. A driven gear 92 as the second gear, which is engaged with the pinion gear 76 mentioned above, and an interaxial distance maintaining member 94 as a second outer peripheral surface portion, are each mounted on the support shaft 90 in a state capable of turning.

The interaxial distance maintaining member 94 has a disc shape, and in its central portion, a gear fixing hole 96 is formed into which the support shaft 90 is pressed into. Further, a gear fixing portion 98 is provided around the gear fixing hole 96. The gear fixing portion 98 is formed into a partially cut disc shape (almost D shape) to fix the driven gear 92. The driven gear 92 can turn integrally with the interaxial distance maintaining member 94 by pressing its central portion into the gear fixing portion 98.

It has been described that the driven gear 92 is pressed into the interaxial distance maintaining member 94, which is not limited to this. For example, they may be bonded with an adhesive or the like, and may be constituted so that the driven gear 92 and the interaxial distance maintaining member 94 can turn integrally.

Furthermore, a C ring 100, which is a so-called C-shaped spring member, is fitted and fixed at an end portion of the support shaft 90. This C ring 100 prevents the driven gear 92 and the interaxial distance maintaining member 94 from coming off from the support shaft 90.

In the gear structure having such constitution, assembling of the gears is done in the following manner.

Specifically, first, the interaxial distance maintaining member 94, and the driven gear 92 fixed on the interaxial distance maintaining member 94 are inserted through by the support shaft 90 provided on the bottom board 78. Then, the interaxial distance maintaining member 94 and the driven gear 92 are fixed on a boss of the support shaft 90, and in this state, the C ring 100 is fitted and fixed at the end portion of the support shaft 90.

On the other hand, the motor shaft 74 extended from the motor bearing 72 of the motor 70 is pressed into the pinion gear 76 with which the interaxial distance maintaining disc 78 is coaxially provided. Then, the interaxial distance maintaining disc 78, and the motor shaft 74 on which the pinion gear 76 is mounted are inserted through the bottom board hole 80 formed on the bottom board 78.

Here, an interaxial distance maintaining circumferential surface 78a of the interaxial distance maintaining disc 78, which is the first outer peripheral surface portion, and an interaxial distance maintaining circumferential surface 94a of the interaxial distance maintaining member 94, which is the second outer peripheral surface portion, contact each other. At this point, as to the interaxial distance maintaining circumferential surface 78a and the interaxial distance maintaining circumferential surface 94a, position is decided between the screw fixing holes 82, 82 formed on the bottom board 78 and the screw holes 84, 84 formed on the motor 70. Then, the motor fixing screws 86, 86 are tightened, thereby fixing the motor 70 on the bottom board 78 while the interaxial distance maintaining circumferential surface 78a and the interaxial distance maintaining circumferential surface 94a are contacting each other.

As described above, the interaxial distance maintaining disc 78 (interaxial distance maintaining circumferential surface 78a) and the interaxial distance maintaining member 94 (interaxial distance maintaining circumferential surface 94a) contact each other so as to rotate. At the same time, the pinion gear 76 as the first gear and the driven gear 92 as the second gear engage with each other.

It should be noted that a backlash portion formed between the teeth of the pinion gear 76 and the teeth of the driven gear 92 may be at a contact strength level in which the surfaces of the interaxial distance maintaining circumferential surface 78a and the interaxial distance maintaining circumferential surface 94a would relatively move to be able to slide. This contact strength should rather be as little as possible, and the strength is preferably 0.

Now, as shown in FIG. 9, if a center distance to be obtained is L, this distance L is a distance from an axial center of the motor shaft 74 to an axial center of the support shaft 90. Then, the distance from an axial center of the interaxial distance maintaining disc 78 to the interaxial distance maintaining circumferential surface 94a of the first outer peripheral surface portion, that is, a radius, is R1, and the distance from the center of the interaxial distance maintaining member 94 to the interaxial distance maintaining circumferential surface 94a of the second outer peripheral surface portion, that is, a radius, is R2. This shows that R1+R2 =L, and that the sum of the radius R1 of the interaxial distance maintaining disc 78 and the radius R2 of the interaxial distance maintaining member 94 in a state where they contact each other will be the desired distance L.

Therefore, if the interaxial distance maintaining disc 78 (interaxial distance maintaining circumferential surface 78a) and the interaxial distance maintaining member 94 (interaxial distance maintaining circumferential surface 94a) are made to contact each other so as to fix the motor 70, it is possible to set and keep a space between the axes of the gears at a desired certain distance. Thus, an efficient transmission of the driving force can be achieved.

However, even if the contact between the interaxial distance maintaining circumferential surface 78a and the interaxial distance maintaining circumferential surface 94a is severed when the screws 86 are tightened, that is, even if their axes move away, no functional problem occurs as long as a distance between the axes is slightly increases. More specifically, the outer peripheral surfaces only need to contact or adjoin each other. In other words, the gears would never be set in a direction to decrease the backlash, and the backlash does not vanish.

It should be noted that, in the fourth embodiment described above, as to the relationship of the diameter size between the pinion gear 76 and the interaxial distance maintaining disc 78 and between the driven gear 92 and the interaxial distance maintaining member 94, as long as the interaxial distance maintaining portion 78 and the interaxial distance maintaining member 94 are built to contact, their size may be larger or smaller than the diameter of the respective gears.

Furthermore, in the fourth embodiment described above, the pinion gear 76, interaxial distance maintaining disc 78, driven gear 92 and interaxial distance maintaining portion 94 are constituted of materials such as plastics, aluminum and brass.

Still further, in FIGS. 8 and 9, the interaxial distance maintaining member 94 is illustrated as it has a stepped portion to have an opening in between with the driven gear 92, and this is provided so that the interaxial distance maintaining member 94 and the interaxial distance maintaining disc 78, and the driven gear 92 and the pinion gear 76 will surely catch each other. Therefore, no opening may be provided between the interaxial distance maintaining member 94 and the driven gear 92.

It should be noted that the gear structure in the present invention is not limited to involute gears, but is also very useful in cycloid gears that do not permit deviation between axes.

Therefore, the present invention is not limited to the above embodiments, but alternatively, various modifications can be made and obtained without departing from its gist at the stage of execution. Further, the invention at various stages is included in each of the above embodiments, and the proper combination of a plurality of disclosed constituent requirements makes it possible to extract various kinds of invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A rotary transmission device comprising:
a first rotary member having a plurality of radial concave portions around a rotary central axis in the vicinity of the rotary central axis; and
a second rotary member formed as a gear, a tooth width of each tooth of the gear being reduced from a tip of the tooth to a halfway point of a tooth height, a tooth portion of from the halfway point of the tooth height to a tooth root being fitted into the plurality of concave portions, whereby the second rotary member does not relatively rotate with the first rotary member.

2. The rotary transmission device according to claim 1, wherein at least one of the first rotary member and the second rotary member is formed of a metallic material.

3. The rotary transmission device according to claim 1, further comprising coupling means coupled in a fastened and fitted state between the first rotary member and the second rotary member to integrally couple the first rotary member and the second rotary member.

4. The rotary transmission device according to claim 3, wherein the coupling means has a fitting hole provided in the first rotary member and a fitting shaft provided in the second rotary member, they being coupled to each other in a fastened and fitted state.

5. The rotary transmission device according to claim 1, wherein the first rotary member is constituted of a gear.

6. The rotary transmission device according to claim 1, wherein the first rotary member is constituted of a member which intermittently interrupts a photointerruptor optical path by rotation.

7. The rotary transmission device according to claim 1, wherein the first rotary member is constituted of a pulley.

8. The rotary transmission device according to claim 1, wherein the first rotary member and the second rotary member are each constituted of a gear.

9. A rotary transmission device comprising:
a first rotary member having a plurality of radial concave portions around a rotary central axis in the vicinity of the central axis; and
a second rotary member which is a gear, having a thin portion as a gear portion in which a tooth width of each tooth of the gear is additionally processed to reduce the thickness from a tip of the tooth to a halfway point of a tooth height, and a plurality of thick portions which are tooth portions and are not additionally processed from the halfway point of the tooth height to a tooth root, the plurality of thick portions being fitted into the plurality of concave portions, respectively, whereby the second rotary member does not relatively rotate with the first rotary member.

10. The rotary transmission device according to claim 9, further comprising a tapered portion between the thin portion and the thick portion of the second rotary member.

11. The rotary transmission device according to claim 9, wherein at least one the first rotary member and the second rotary member is formed of a metallic material.

12. The rotary transmission device according to claim 9, further comprising coupling means coupled in a fastened and fitted state between the first rotary member and the second rotary member to integrally couple the first rotary member and the second rotary member.

13. The rotary transmission device according to claim 12, wherein the coupling means has a fitting hole provided in the first rotary member and a fitting shaft provided in the second rotary member, they being coupled to each other in a fastened and fitted state.

14. The rotary transmission device according to claim 9, wherein the first rotary member is constituted of a gear.

15. The rotary transmission device according to claim 9, wherein the first rotary member is constituted of a member which intermittently interrupts a photointerruptor optical path by rotation.

16. The rotary transmission device according to claim 9, wherein the first rotary member is constituted of a pulley.

17. The rotary transmission device according to claim 9, wherein the first rotary member and the second rotary member are constituted of gears.

18. A gear mechanism comprising:
a first gear;
a second gear to engage with the first gear;
a first outer peripheral surface portion provided to rotate coaxially and integrally with the first gear; and
a second outer peripheral surface portion provided to rotate coaxially and integrally with the second gear,
wherein to keep a space between axes of the first gear and the second gear at a certain distance, the first outer peripheral surface portion and the second outer peripheral surface portion are allowed to contact or adjoin each other, so that the first gear engages with the second gear.

19. A gear mechanism comprising:
a first gear;
a second gear to engage with the first gear;
a first outer peripheral surface portion provided coaxially and integrally with the first gear; and
a second outer peripheral surface portion to rotate coaxially and integrally with the second gear,
wherein to keep a space between axes of the first gear and the second gear at a certain distance, the first outer peripheral surface portion and the second outer peripheral surface portion are allowed to contact or adjoin each other, so that the first gear engages with the second gear.

20. The gear mechanism according to claim 18, wherein the first outer peripheral surface portion and the second outer peripheral surface portion are rolling.

21. The gear mechanism according to claim 19, wherein the first outer peripheral surface portion and the second outer peripheral surface portion are rolling.

22. The gear mechanism according to claim 18, wherein the contact of the first outer peripheral surface portion and the second outer peripheral surface portion makes it possible to slidably move a backlash portion formed between a teeth portion of the first gear and a teeth portion of the second gear.

23. The gear mechanism according to claim 19, wherein the contact of the first outer peripheral surface portion and the second outer peripheral surface portion makes it possible to slidably move a backlash portion formed between a teeth portion of the first gear and a teeth portion of the second gear.

24. The gear mechanism according to claim 20, wherein the contact of the first outer peripheral surface portion and the second outer peripheral surface portion makes it possible to slidably move a backlash portion formed between a teeth portion of the first gear and a teeth portion of the second gear.

25. The gear mechanism according to claim 21, wherein the contact of the first outer peripheral surface portion and the second outer peripheral surface portion makes it possible to slidably move a backlash portion formed between a teeth portion of the first gear and a teeth portion of the second gear.
